(19) United States
(12) Patent Application Publication
(10) Pub. No.: US 2004/0179929 A1
(43) Pub. Date: Sep. 16, 2004

(54) Cart with inclined floor auger

(75) Inventor: Michael D. Van Mill, Shell Rock, IA (US)

Correspondence Address: ROTHWELL, FIGG, ERNST & MANBECK, P.C., 1425 K STREET, N.W., SUITE 800, WASHINGTON, DC, 20005, US

(73) Assignee: UNVERFERTH MANUFACTURING COMPANY, INC., Kalida, OH

(21) Appl. No.: 10/386,526

(22) Filed: Mar. 13, 2003

(51) Int. Cl. B60P 1/00

(52) U.S. Cl. 414/526

(57) ABSTRACT

A self-unloading cart has a hopper with a sump and several inclined floor portions arranged substantially symmetrically about a longitudinal plane through the sump and extending generally outward and upward from the sump. An inclined floor auger having a inlet underneath the sump and an outlet at a predetermined height above the inlet is disposed beneath a forward one of inclined floor portions and extends to a front of the cart. The inclined floor auger has a first helical blade disposed rotatably about an axial centerline of the inclined floor auger within a hollow, partially enclosed first cylinder. A vertical folding auger with an entrance end connectably disposed to the outlet for receiving material transported by the inclined floor auger and a discharge end is disposed proximate to the front of the cart. The vertical folding auger has a second helical blade disposed rotatably within a hollow, enclosed second cylinder. An axle having a center is disposed fixedly beneath the sump, and the axle center, the sump and the axial centerline lie substantially in the longitudinal plane of symmetry.

### FIELD OF THE INVENTION

The invention relates to self-unloading carts, and particularly to carts that unload by means of an auger.

### DESCRIPTION OF THE RELATED ART

Self-unloading carts may be used to haul loose or granular material such as grain or corn. Self-unloading carts are often used in agriculture to haul materials around farms, such as e.g., from a combine to a truck or a wagon. Such carts are often pulled by tractors.

The cart is loaded by pouring the material in the top of a hopper. The cart may have an auger running underneath the cart into which the material may be emptied. The auger then screws the material out from underneath the hopper, possibly into another auger that raises the material to a higher level, to unload the cart.

The hopper on a self-unloading cart often has an inclined floor arranged around a sump so that the material slides towards the sump. Such an inclined floor obviates the necessity of including some mechanical means to propel material towards the sump.

Dry materials like grains and the like may require a steeper incline than e.g. a liquid of comparable volume, since a relatively solid material like a grain may support shear, allowing it to be stacked. Grain, for example, will become compressed in the hopper by grains held above it. Grains may also ferment slightly in the manner of silage if, e.g. the hopper is used for temporary storage. Fermenting may break down the walls of the individual grains slightly, making them adhere to one another and producing a relatively solid mass. Such a mass may support shear and may thus require relatively steeply inclined walls.

Steeply inclined walls around the sump, however, reduce the volume available for grain capacity. A sump placed to one side of a hopper may require a long inclined floor. Such a floor may require a long auger to travel the length of the cart to the sump. Furthermore, augers are often oriented at an angle to the direction of travel of the cart, emptying at one side of the cart. Such augers may thus place more mass on that side of the cart.

Since steeply inclined walls around the sump reduce the volume available for grain capacity, a hopper often has vertical walls above the inclined walls to provide some compensation for the capacity lost to the inclination of the walls. A hopper may thus have a center of gravity that is relatively high. Such a high center of gravity may reduce the stability of a vehicle, such as a cart, upon which the hopper is mounted. Instability may lend a cart that carries the hopper a tendency to tip.

A potential for instability may be exacerbated by the manner in which such carts are used. Carts may be pulled over, e.g. plowed fields. Plowed fields are often characterized by undulating furrows running across or around the landscape. One of the wheels of a cart may be climbing a ridge of soil between two furrows while the other is running along the bottom of a neighboring furrow. Carts traversing furrows may thus be leaning and rocking back and forth, across the hitch pont. A center of gravity of such a cart that becomes placed outboard of one of the wheels during such leaning may well cause the entire cart to fall over.

### SUMMARY OF THE INVENTION

In one embodiment a self-unloading cart has a hopper with a sump and several inclined floors arranged substantially symmetrically about a longitudinal plane through the sump and extending generally outward and upward from the sump. An inclined floor auger having a inlet underneath the sump and an outlet at a predetermined height above the inlet is disposed beneath a forward one of inclined floors and extends to a front of the cart. The inclined floor auger has a first helical blade disposed rotatably about an axial centerline of the inclined floor auger within a hollow, partially enclosed first cylinder. A vertical folding auger with an entrance end connectably disposed to the outlet for receiving material transported by the inclined floor auger and a discharge end is disposed proximate to the front of the cart. The vertical folding auger has a second helical blade disposed rotatably within a hollow, enclosed second cylinder. An axle having a center is disposed fixedly beneath the sump, and the axle center, the sump and the axial centerline lie substantially in the longitudinal plane of symmetry.

### BRIEF DESCRIPTION OF THE SEVERAL VIEWS OF THE DRAWINGS

FIG. 1 is a front view of a self-unloading cart according to a first embodiment of the invention;

FIG. 2 is a side view of the self-unloading cart shown in FIG. 1; and

FIG. 3 is a top view of the self-unloading cart shown in FIG. 1.

### DETAILED DESCRIPTION OF THE PREFERRED EMBODIMENTS

A sump that covers the length a hopper may require a longer inclined floor auger than a centrally located sump, or a sump that ends about halfway to the rear of the hopper. Since such a sump may require a longer auger to travel the length of the cart, and long augers weigh more, it would be desirable for a sump to end about halfway to the rear of the hopper to minimize the length of the auger. A shortened floor auger may reduce the cost as well as the weight of the cart.

If a center of gravity of a cart moves too far to one side of a longitudinal centerline of the cart when it leans, the cart may tip over. Since a high center of gravity will move further outboard per angle of lean than a lower one, it would be desirable for the cart to have a relatively low center of gravity. The lower center of gravity may be of particular importance when traversing furrows or ditches with the cart in tow.

Furthermore, since a center of gravity that is off-center when the cart is standing upright will have a shorter distance to travel during a lean, it would be desirable to locate a center of gravity as closely as possible to the center of the cart, such as near a longitudinal plane of symmetry. It would thus be desirable for the sump, floor auger, and associated hardware to be distributed substantially symmetrically about a longitudinal plane through center of the cart. The increased stability associated with a centrally located center of gravity, as well as with symmetry with respect to the cart centerline, may provide an extra margin of safety against the cart rolling over.

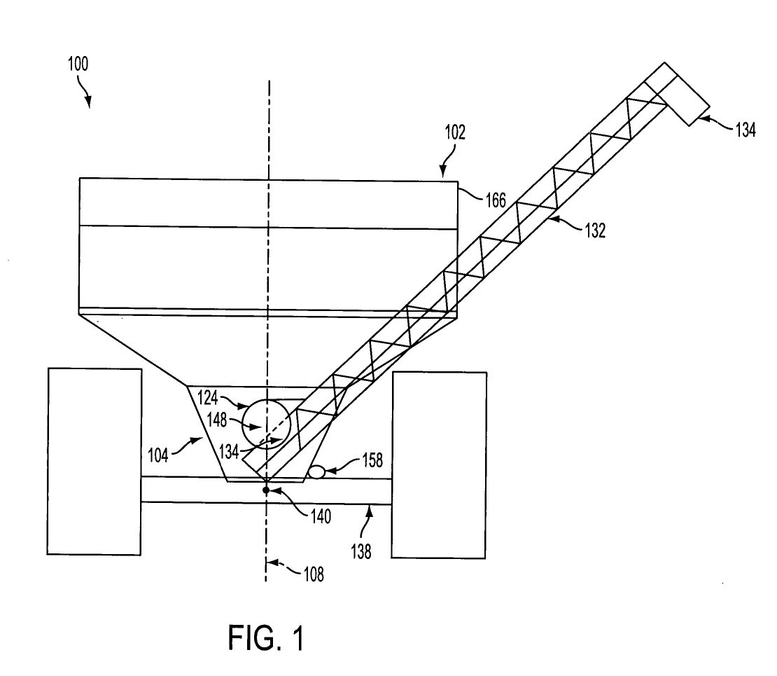

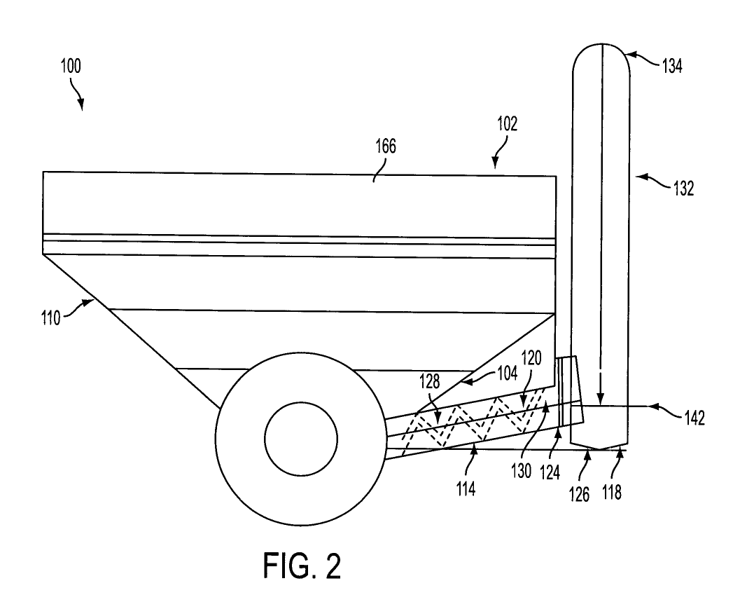

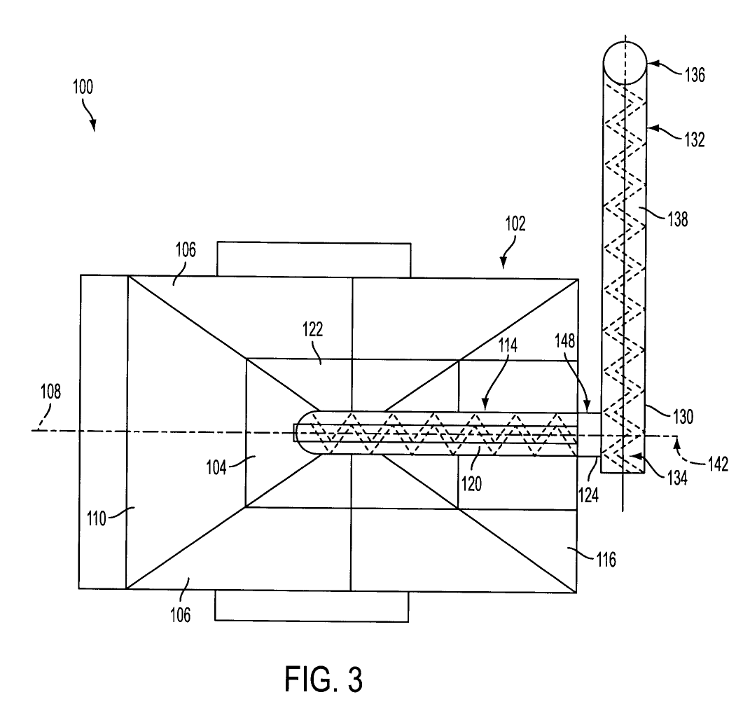

In FIGS. 1 through 3 is shown a cart 100 according to a first embodiment of the invention. Cart 100 may have a hopper 102 with a sump 104 and a plurality of inclined floor portions 106 extending generally outward and upward from sump 104. Sump 104 may thus be located substantially centrally under hopper 102. In a preferred embodiment, sump 104 may end about halfway to the rear of hopper 102.

Inclined floor portions 106 may be arranged substantially symmetrically about a longitudinal plane 108 of hopper 102 through sump 104. A substantially vertical wall 166 may extend upward from an upper end 168 of at least some of inclined floor portions 106.

An inclined floor auger 114 may be disposed beneath a forward one 116 of inclined floor portions 106 and extend to a front 118 of cart 100. Inclined floor auger 114 may be placed substantially proximate to an underside of forward inclined floor portion 116 to maximize a carrying capacity of hopper 102. Furthermore, inclined floor auger 114 may be placed substantially proximate to an underside of forward inclined floor portion 116 to lower a center of gravity of cart 102. A rear one 110 of inclined floor portions 106 may urge a material contained in hopper 102 toward sump 104.

Inclined floor auger 114 may be a hollow, partially enclosed first cylinder 120 having an inlet 122 substantially proximate to sump 104, an outlet 124 at a predetermined height 126 above inlet 122, and a first helical blade 128 rotating within first cylinder 120 about an axial centerline 130. A first actuator 148 may be connected to first helical blade 128 to drive first helical blade 128. First actuator 148 may be, e.g. a hydraulic, electrical, or mechanical actuator, such as a hydraulic motor or a clutch-driven actuator deriving power from a tractor engine power take off (PTO).

An axle 138 having a center 140 may be disposed fixedly beneath sump 104. Axle center 140, sump 104 and axial centerline 130 may lie substantially in longitudinal plane 108. Thus most of the components of cart 102 will be distributed substantially symmetrically about longitudinal plane 108.

A vertical folding auger 132 may be disposed proximate to front 118 of cart 100. Vertical folding auger 132 may have an entrance end 134 connected to outlet 124 for receiving material transported by inclined floor auger 114 and a discharge end 134. Vertical folding auger 132 may be comprised of a hollow, enclosed second cylinder 136 having a second helical blade 138 rotating within second cylinder 136. A second actuator 150 may be connected to second helical blade 138 to drive second helical blade 138. Second actuator 150 may be, e.g. a hydraulic, electrical, or mechanical actuator, such as a hydraulic motor or a clutch-driven actuator deriving power from a tractor engine PTO.

A third actuator 158 may rotate vertical folding auger 132 about an axis of rotation 142 between a transport position and a discharge position. Axis of rotation 142 may be substantially normal to axle 138 in longitudinal plane 108. Third actuator 158 may be, e.g. a hydraulic, electrical, or mechanical actuator, such as a hydraulic motor or a clutch-driven actuator deriving power from a tractor engine PTO.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. A self-unloading cart comprising:
a hopper having a sump and a plurality of inclined floor portions extending generally outward and upward from said sump, said inclined floor portions arranged substantially symmetrically about a longitudinal plane through the sump;
an inclined floor auger disposed beneath a forward one of said plurality of inclined floor portions and extending to a front of the cart, said inclined floor auger comprised of a hollow, partially enclosed first cylinder having an inlet substantially proximate to said sump, an outlet at a predetermined height above said inlet, and a first helical blade disposed rotatably within said first cylinder about an axial centerline of said inclined floor auger;
a vertical folding auger disposed proximate to the front of the cart, said vertical folding auger having an entrance end connectably disposed proximate to said outlet for receiving material transported by said inclined floor auger and a discharge end, said vertical folding auger comprised of a hollow, enclosed second cylinder having a second helical blade disposed rotatably within said second cylinder;
an axle having a center disposed fixedly beneath said sump,
wherein said axle center, said sump and said axial centerline lie substantially in said longitudinal plane.

2. The self-unloading cart of claim 1, wherein said folding auger is rotatable about an axis of rotation of said entrance end between a transport position and a discharge position, said axis of rotation being substantially normal to said axle in said longitudinal plane.

3. The self-unloading cart of claim 1, further comprising:
a first actuator connected to said first helical blade to drive rotatably said first helical blade; and
a second actuator connected to said second helical blade to drive rotatably said second helical blade.

4. The self-unloading cart of claim 1, further comprising:
a third actuator for rotating said vertical folding auger about said axis of rotation between said transport and said discharge positions.

5. The self-unloading cart of claim 1, further comprising:
a substantially vertical wall extending upward from an upper end of at least some of each of said plurality of inclined floor portions.
